(19) United States
(12) Patent Application Publication
(10) Pub. No.: US 2026/0352691 A1
(43) Pub. Date: Nov. 5, 2026

(54) METHOD, DEVICE AND COMPUTER PROGRAM PRODUCT FOR NETWORK SECURITY EVALUATION

(71) Applicant: ZTE CORPORATION, Guangdong (CN)

(72) Inventors: Leyi ZHANG, Guangdong (CN); Kunpeng CAO, Guangdong (CN)

(73) Assignee: ZTE CORPORATION, Guangdong (CN)

(21) Appl. No.: 19/488,363

(22) PCT Filed: Jun. 1, 2023
(86) PCT No.: PCT/CN2023/097769

§ 371 Date: Nov. 26, 2025

(51) Int. Cl. H04L 9/40

(52) U.S. Cl. CPC H04L 63/1433

(57) ABSTRACT

A network security evaluation method is disclosed. The method comprises quantifying, by a processor, one or more quantified indicators indicating one or more risk levels of a network according to security data of the network; and analyzing, by the processor, the one or more quantified indicators for a security improvement of the network in response to the one or more risk levels of the network being greater than one or more criteria; wherein the one or more quantified indicators indicate an ability of at least one of: a security protection function of the network, a security detection function of the network, or a security recovery function of the network.

This document is directed generally to a method, device and computer program product for an evaluation of an electronic system, and in particular to method, device and computer program product for a network security evaluation.

With the sharp increase of internal and external network attacks and the rapid changes of network environment, unprecedented challenges are encountered in the cybersecurity field. As a consequence, it is imperative to accurately determine and predict the security status of the network, identify the security issues and apply countermeasures according to its risk preference.

This document relates to methods, systems, and computer program products for a network security evaluation.

One aspect of the present disclosure relates to a network security evaluation method. In an embodiment, the network security evaluation method includes: quantifying, by a processor, one or more quantified indicators indicating one or more risk levels of a network according to security data of the network; and analyzing, by the processor, the one or more quantified indicators for a security improvement of the network in response to the one or more risk levels of the network being greater than one or more criteria; wherein the one or more quantified indicators indicate an ability of at least one of: a security protection function of the network, a security detection function of the network, or a security recovery function of the network.

Another aspect of the present disclosure relates to an evaluation device. In an embodiment, the evaluation device includes a processor. The processor is configured to: quantify one or more quantified indicators indicating one or more risk levels of the network according to security data of the network; and analyze the one or more quantified indicators for a security improvement of the network in response to the one or more risk levels of the network being greater than one or more criteria, wherein the one or more quantified indicators indicate an ability of at least one of: a security protection function of the network, a security detection function of the network, or a security recovery function of the network.

Various embodiments may preferably implement the following features:

Preferably, the one or more quantified indicators comprises at least one of:
a personnel protection ability;
a system protection ability;
a data protection ability;
a risk detection ability;
an incident detection ability;
an incident recovery ability;
a vulnerability handling ability; or
an emergency response ability.

Preferably, the personnel protection ability is determined by training information of network operators for the network, and the training information comprises at least one of: information of an adequacy level of a security training of one of the network operators or information of a qualification level of a security training of one of the network operators.

Preferably, the personnel protection ability H_{α} is determined by:

$${H}_{a} = \frac{{\sum }_{i = 1}^{{N}_{h}} {H}_{{a}_{i}}}{{N}_{h}}$$

wherein Nₕ indicates a total amount of network operators for the network,
wherein H_{α}_{ᵢ}=0.5 Hp; +0.5H_{c}_{ᵢ},
wherein H_{b}_{ᵢ} indicates an adequacy level of a security training of operator i, and
wherein H_{c}_{ᵢ} indicates a qualification level of a security training of operator i.

Preferably, the system protection ability is determined by protection information of devices in the network, and the protection information comprises at least one of:
a strength of an identity authentication of one of the devices;
an indication indicating whether one of the devices is installed with a self-protection software;
an indication indicating whether a patch of one of the devices meets certain requirements;
an indication indicating whether one of the devices is intruded;
an indication indicating whether one of the devices has undergone a security reinforcement;
an indication indicating whether one of the devices has a software whitelist enabled;
an indication indicating whether one of the devices has a redundancy design; or
an indication indicating whether one of the devices has an account security policy enabled.

Preferably, the system protection ability Sa is determined by:

$${S}_{a} = \frac{{\sum }_{i = 1}^{{N}_{s}} {S}_{{a}_{i}}}{{N}_{s}}$$

wherein Nₛ indicates a total amount of devices in the network,
wherein

$${S}_{{a}_{i}} = \frac{{S}_{{b}_{i}} + {S}_{{c}_{i}} + {S}_{{d}_{i}} + {S}_{{e}_{i}} + {S}_{{f}_{i}} + {S}_{{g}_{i}} + {S}_{{h}_{i}} + {S}_{{j}_{i}}}{18} ,$$

wherein S_{b}_{ᵢ} indicates a strength of an identity authentication of device i;
wherein S_{c}_{ᵢ} indicates whether device i is installed with a self-protection software;
wherein S_{d}_{ᵢ} indicates whether a patch of device i meets certain requirements;
wherein Sₑ_{ᵢ} indicates whether device i is intruded;
wherein S_{f}_{ᵢ} indicates whether device i is undergone a security reinforcement;
wherein S_{g}_{ᵢ} indicates whether device i has a software whitelist enabled;
wherein Sₕ_{ᵢ} indicates whether device i has a redundancy design; and
wherein Sⱼ_{ᵢ} indicates whether device i has an account security policy enabled.

Preferably, the data protection ability is determined by information of dealing or storing sensitive data in the network, and the information of dealing or storing sensitive data in the network comprises at least one of:
an indication indicating whether the sensitive data is stored in an encrypted manner;
an indication indicating whether the sensitive data is transmitted in an encrypted manner;
an indication indicating whether the sensitive data is backed up in an offline or remote manner; or
an indication indicating whether the network clears the sensitive data when the network is repaired or scrapped.

Preferably, the data protection ability D_{α} is determined by:

$${D}_{a} = \frac{{D}_{b} + {D}_{c} + {D}_{d} + {D}_{e}}{20}$$

wherein D_{b} indicates whether sensitive data in the network is stored in an encrypted manner;
wherein D_{c} indicates whether sensitive data in the network is transmitted in an encrypted manner;
wherein D_{d} indicates whether sensitive data in the network is backed up in an offline or remote manner; and
wherein Dₑ indicates whether the network clears sensitive data in the network when the network is repaired or scrapped.

Preferably, the risk detection ability is determined by risk detection information of devices in the network, and the risk detection information comprises at least one of:
a number of devices undergoing both vulnerability scanning and baseline compliance checks; or
a number of devices undergoing only baseline compliance checks.

Preferably, the risk detection ability R_{α} is determined by:

$${R}_{a} = \frac{{R}_{b} + 0.5 {R}_{c}}{{N}_{s}}$$

wherein Nₛ indicates a total amount of devices in the network;
wherein R_{b} indicates a number of devices undergoing both vulnerability scanning and baseline compliance checks; and
wherein R_{c} indicates a number of devices undergoing only baseline compliance checks.

Preferably, the incident detection ability is determined by incident detection information of the network, and the incident detection information comprises at least one of:
a number of times of security incidents reported within a pre-determined time;
a number of times of security incidents wrongly reported within a pre-determined time; or
a number of security incidents occurring within a pre-determined time.

Preferably, the incident detection ability I_{α} is determined by:

$${I}_{a} = \frac{{I}_{b} - {I}_{c}}{{I}_{d}}$$

wherein I_{b} indicates a number of times of security incidents reported within a pre-determined time;
wherein I_{c} indicates a number of times of security incidents wrongly reported within a pre-determined time; and
wherein I_{d} indicates a number of security incidents occurring within the pre-determined time.

Preferably, the incident recovery ability is determined by incident recovery information of the network, and the incident recovery information comprises at least one of:
a number of incidents contained or eradicated during a first pre-determined time; or
a number of incidents occurring during a second pre-determined time.

Preferably, the incident recovery ability C_{α} is determined by:

$${C}_{a} = \frac{{C}_{b}}{{C}_{c}}$$

wherein C_{b} indicates a number of incidents contained or eradicated during a first pre-determined time; and
wherein C_{c} indicates a number of incidents occurring during a second pre-determined time.

Preferably, the vulnerability handling ability is determined by vulnerability handling information of the network, and the vulnerability handling information comprises at least one of:
a number of high-risk and medium-risk vulnerabilities mitigated or resolved within a third pre-determined time; or
a number of high-risk and medium-risk vulnerabilities identified within a fourth pre-determined time.

Preferably, the vulnerability handling ability Va is determined by:

$${V}_{a} = \frac{{V}_{b}}{{V}_{c}}$$

wherein V_{b} indicates a number of high-risk and medium-risk vulnerabilities mitigated or resolved within a third pre-determined time; and
wherein V_{c} indicates a number of high-risk and medium-risk vulnerabilities identified within a fourth pre-determined time.

Preferably, the emergency response ability is determined by emergency response information of systems in the network, and the emergency response information comprises at least one of:
a number of systems in the network passing emergency drills; or
a number of systems in the network.

Preferably, the emergency response ability E_{α} is determined by:

$${E}_{a} = \frac{{E}_{b}}{{E}_{c}}$$

wherein E_{b} indicates a number of systems in the network passing emergency drills; and
wherein E_{c} indicates a number of systems in the network.

The present disclosure relates to a computer program product comprising a computer-readable program medium code stored thereupon, the code, when executed by a processor, causing the processor to implement a network security evaluation method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

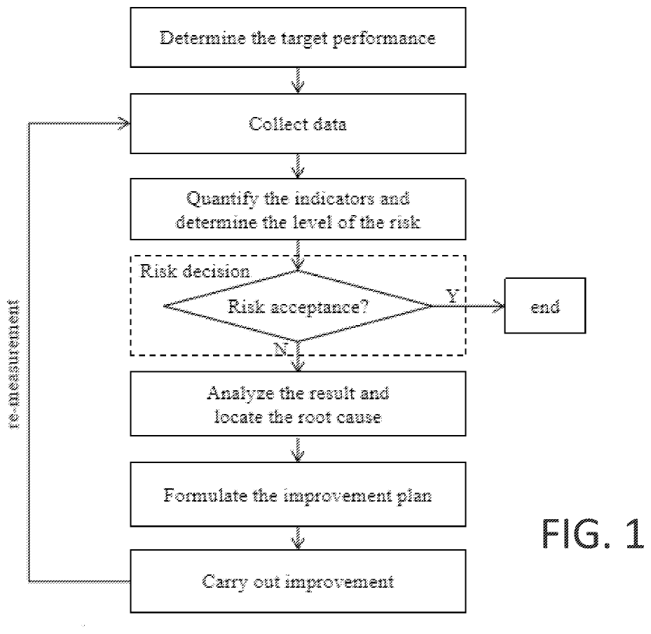

FIG. 1 shows a flowchart of a method according to an embodiment of the present disclosure.

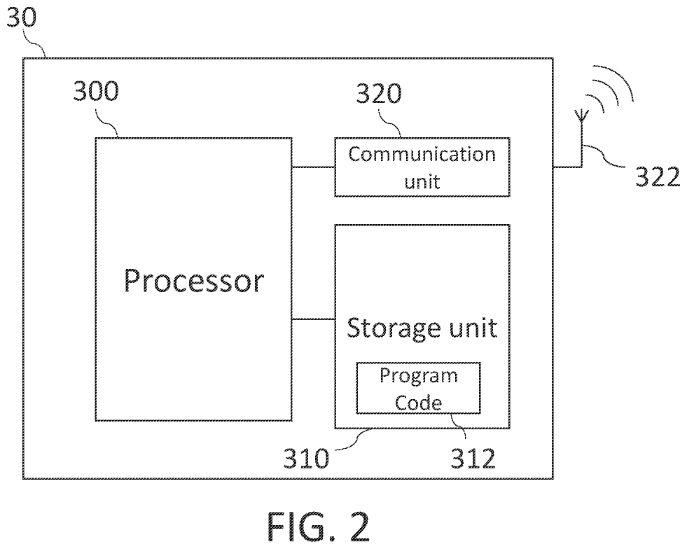

FIG. 2 shows an example of a schematic diagram of an evaluation device according to an embodiment of the present disclosure.

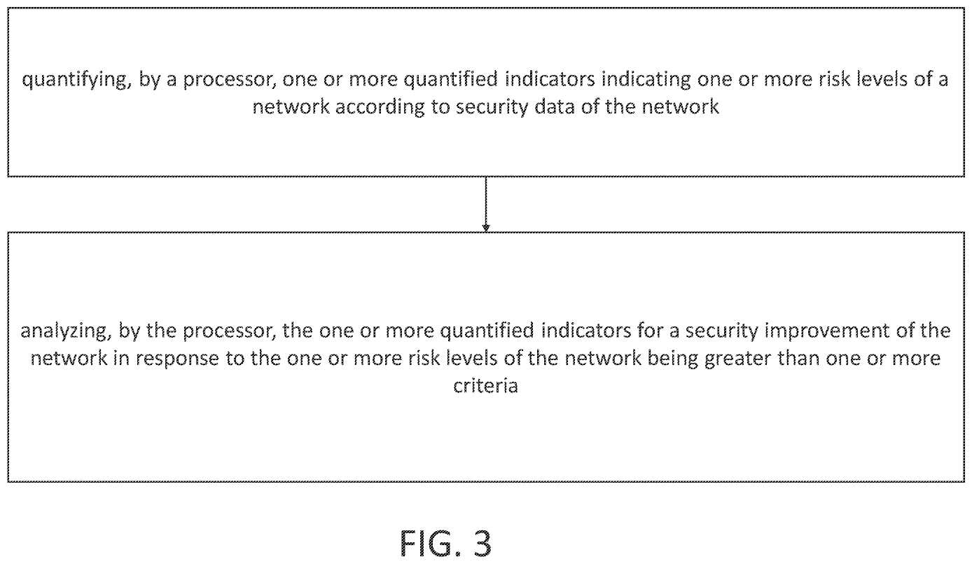

FIG. 3 shows a flowchart of an evaluation method according to some embodiments of the present disclosure.

Some embodiments of the present disclosure provide an indicator system to characterize the security status of the network, which may use a quantifiable manner to evaluate the security abilities and reflect the important change trend of the network.

In some embodiments, since the network has different security functions, i.e., security protection, security detection and security recovery, different indicators to describe the abilities of the network to realize each function may be used. In some embodiments, for each indicator, the quantification of it, the evaluation of its quantification value, and the measurement frequency are provided.

FIG. 1 shows a flowchart of a method according to an embodiment of the present disclosure.

The method includes at least one of the following steps:
Step 1) Determine the target performance
Identify the network and related systems and assets in the network and determines the target performance of the network.
Step 2) Collect data
Collect measurement data (also referred to as security data) manually or automatically from various sources, such as logs, reports, and alarms (will be specified below).
Step 3) Quantify the indicators and determine the level of the risk
Quantify the indicators and evaluate one or more risk levels. In some embodiments, the risk level may include high risk, medium risk or low risk. In some embodiments, the one or more risk levels may be one or more risk level values.
Step 4) Risk decision
Based on actual requirements (e.g., the risk preferences, the risk tolerance, and/or the information of the budget limit), decide whether the risk level(s) is acceptable. In some embodiments, one or more criteria may be determined based on the actual requirements. In some embodiments, whether the risk level(s) is acceptable may be decided according to whether the one or more risk levels are greater than the one or more criteria.
Step 5) Analyze the result and locate the root cause
When the risk level(s) is not acceptable, perform an analysis to identify the gap between actual and desired performance (defined in Step 1), and determine the root cause of poor performance.
Step 6) Formulate the improvement plan
Design an improvement plan in accordance with the priories of risks, information of costs, etc.
Step 7) Carry out improvement
Apply improvement actions as scheduled and ensure that they are traceable.

In some embodiments, Steps 1 to 7 may be performed by different devices. In some embodiments, at least a part of Steps 1 to 7 may be performed by the same device. For example, the evaluation device performs Step 3 may decide whether the risk level(s) is acceptable (Step 4), perform the analysis in Step 5, generate the improvement plan in Step 6, and transmit the improvement plan to another device to perform the improvement actions.

In some embodiments of the present disclosure, an indicator system is provided for network security evaluation. In some embodiments, the PDR (Protection, Detection, and Recovery) model used for a cybersecurity model consists of three basic functions: security protection, security detection and security recovery. In some embodiments, the indicator system may use indicators to characterize the three security functions. The composition of the indicator system and the relationship between the indicators and security functions are shown in table below.

| Security function | indicators |
|---|---|
| Security Protection | Personnel protection ability |
| | System protection ability |
| | Data protection ability |
| Security Detection | Risk detection ability |
| | Incident detection ability |
| Security Recovery | Incident recovery ability |
| | Vulnerability handling ability |
| | Emergency response ability |

### Security Protection

In some embodiments, the security protection function is important in the whole network security. To fully describe the security protection ability, three indicators are provided to evaluate the security level from the aspects of the operators, the system and the data.

### (1) Personnel Protection Ability

People may be considered as a weak point in security activities. Regardless of which protection technologies are used, savvy attackers have strategies to breach them. To avoid man-caused security incidents due to lack of security knowledge and weak security skills, relevant personnel may be fully trained and have qualified security awareness. Therefore, the operator protection ability H_{α} can be reflected by the result of security training for operators. Details of the indicator Ha are described below. In this embodiment, the larger the H_{α} value, the higher the personnel protection ability.

In some embodiments, the personnel protection ability H_{α} is determined by the training information of network operators for the network, and the training information comprises at least one of: information of an adequacy level of a security training of one of the network operators or information of a qualification level of a security training of one of the network operators.

In some embodiments, the measurement of the personnel protection ability H_{α} may be to ensure that the network operators are fully trained regarding all work scenarios and can correctly exert their security responsibilities.

In some embodiments, the personnel protection ability Ha is determined by:

$${H}_{a} = \frac{{\sum }_{i = 1}^{{N}_{h}} {H}_{{a}_{i}}}{{N}_{h}}$$

wherein Nₕ indicates a total amount of network operators for the network,
wherein H_{α}_{ᵢ}=0.5H_{b}_{ᵢ}+0.5H_{c}_{ᵢ},
wherein H_{b}_{ᵢ} indicates an adequacy level of a security training of operator i, and
wherein H_{c}_{ᵢ} indicates a qualification level of a security training of operator i (for example, if no security breach occurs, the score is 1, otherwise, the score is −1).

In some embodiments, when H_{α}<0.5, the risk level is determined to be high risk. When 0.5≤H_{α}<0.8, the risk level is determined to be medium risk. When 0.8≤H_{α}≤1, the risk level is determined to be low risk. It can be understood that the values for determining the risk level above are merely for illustrative purpose, and other values may be used.

In some embodiments, the measurement frequency of the personnel protection ability H_{α} can be self-defined (e.g., per month, per quarter, half a year, or per year).

In some embodiments, the training information of network operators for the network described above can be obtained or collected from at least one of a training record, an operation ledger, a monitoring video, an audit record, a log record, and/or individual observation information.

It can be understood that one of H_{b}_{ᵢ} or H_{c}_{ᵢ} in the equation for calculating H_{α}_{ᵢ} may be omitted (e.g., H_{α}_{ᵢ}=H_{b}_{ᵢ}).

It can be understood that at least one of the weights of H_{b}_{ᵢ} or H_{c}_{ᵢ} in the equation for calculating H_{α}_{ᵢ} may be changed (e.g., H_{α}_{ᵢ}=0.6H_{b}_{ᵢ}+0.4H_{c}_{ᵢ}).

It can be understood that the score of each factor in the equation for calculating H_{α}_{ᵢ} may be set as another value (e.g., H_{c}_{ᵢ} is set as 0 when security breach occurs device i on operator i).

### (2) System Protection Ability

In some manners, cybersecurity is featured by layered protection. Accordingly, when new security functions are added, additional risks may be introduced. In some embodiments of the present disclosure, the network itself has certain security protection capabilities. Details of the system protection ability are discussed below.

In some embodiments, the measurement of the system protection ability is to ensure that the system itself has self-protection ability and can withstand certain attacks and/or perform issue warnings.

In some embodiments, the system protection ability is determined by the protection information of devices in the network. In some embodiments, the protection information comprises at least one of:
a strength of an identity authentication of one of the devices;
an indication indicating whether one of the devices is installed with a self-protection software (e.g., HIDS (host-based intrusion detection system)) and/or the feature library meets certain requirements;
an indication indicating whether a patch of one of the devices meets certain requirements;
an indication indicating whether one of the devices is intruded;
an indication indicating whether one of the devices has undergone a security reinforcement;
an indication indicating whether one of the devices has a software whitelist enabled;
an indication indicating whether one of the devices has a redundancy design; and/or
an indication indicating whether one of the devices has an account security policy enabled.

For example, the system protection ability Sa is determined by:

$${S}_{a} = \frac{{\sum }_{i = 1}^{{N}_{s}} {S}_{{a}_{i}}}{{N}_{s}}$$

Nₛ indicates a total amount of devices in the network,

$${S}_{{a}_{i}} = \frac{{S}_{{b}_{i}} + {S}_{{c}_{i}} + {S}_{{d}_{i}} + {S}_{{e}_{i}} + {S}_{{f}_{i}} + {S}_{{g}_{i}} + {S}_{{h}_{i}} + {S}_{{j}_{i}}}{18} .$$

S_{b}_{ᵢ} indicates a strength of an identity authentication of device i. For example, S_{b}_{ᵢ} is three when the identify authentication of device i is multi-factor authentication, and S_{b}_{ᵢ} is one when the identify authentication of device i is single-factor authentication.
S_{c}_{ᵢ} indicates whether device i is installed with a self-protection software (e.g., HIDS) and/or the feature library meets certain requirements. For example, if device i is installed with a self-protection software (e.g., HIDS) and the feature library meets certain requirements, S_{c}_{ᵢ} is three, otherwise S_{c}_{ᵢ} is zero.
S_{d}_{ᵢ} indicates whether a patch of device i meets certain requirements. For example, if yes, S_{d}_{ᵢ} is one, otherwise S_{d}_{ᵢ} is zero.
Sₑ_{ᵢ} indicates whether device i is intruded. For example, if yes, Sₑ_{ᵢ} is zero, otherwise Sₑ_{ᵢ} is three.
S_{f}_{ᵢ} indicates whether device i has undergone a security reinforcement. For example, if yes, S_{f}_{ᵢ} is two, otherwise S_{f}_{ᵢ} is zero.
S_{g}_{ᵢ} indicates whether device i has a software whitelist enabled. For example, if yes, S_{g}_{ᵢ} is two, otherwise S_{g}_{ᵢ} is zero.
Sₕ_{ᵢ} indicates whether device i has a redundancy design. For example, if yes, Sₕ_{ᵢ} is two, otherwise Sₕ_{ᵢ} is zero.
Sⱼ_{ᵢ}, indicates whether device i has an account security policy enabled. For example, if yes, Sⱼ_{ᵢ} is two, otherwise Sⱼ_{ᵢ} is zero.

In some embodiments, for a critical system, when S_{α}<0.7, the risk level is determined to be high risk. When 0.7≤S_{α}<0.9, the risk level is determined to be medium risk. When 0.9≤S_{α}≤1, the risk level is determined to be low risk. In some embodiments, for a non-critical system, when S_{α}<0.5, the risk level is determined to be high risk. When 0.5≤S_{α}<0.8, the risk level is determined to be medium risk. When 0.8≤S_{α}≤1, the risk level is determined to be low risk. It can be understood that the values for determining the risk level above are merely for illustrative purpose, and other values may be used.

In some embodiments, the measurement frequency of the system protection ability S_{α} can be self-defined (e.g., per month, per quarter, half a year, or per year).

In some embodiments, the protection information described above can be obtained or collected from at least one of: a product manual, a configuration manual, a manual check record, a security log, a system log, an operation log, a change operation ledger, and/or a security hardening record.

It can be understood that some factors in the equation for calculating S_{α}_{ᵢ} may be omitted, and the denominator may change accordingly (e.g., from 18 to 16).

It can be understood that the values of each factor in the equation for calculating S_{α}_{ᵢ} may be set as different values (e.g., Sⱼ_{ᵢ} is set as 5 when device i has an account security policy enabled), and the denominator may change accordingly (e.g., from 18 to 21).

### (3) Data Protection Ability

Sensitive data is one of the targets of cyber-attacks and is also the security protection core of an organization. Data protection may secure data throughout its lifecycle around confidentiality, integrity, and availability. Details of the data protection ability are discussed below.

In some embodiments, the measurement of the data protection ability is to ensure that sensitive data is stored, transmitted, backed up, and cleared in a secure manner.

In some embodiments, the data protection ability is determined by information of dealing or storing sensitive data in the network, and the information of dealing or storing sensitive data in the network comprises at least one of:
an indication indicating whether the sensitive data is stored in an encrypted manner;
an indication indicating whether the sensitive data is transmitted in an encrypted manner;
an indication indicating whether the sensitive data is backed up in an offline or remote manner; and/or
an indication indicating whether the network clears the sensitive data when the network is repaired or scrapped.

For example, the data protection ability D_{α} is determined by:

$${D}_{a} = \frac{{D}_{b} + {D}_{c} + {D}_{d} + {D}_{e}}{20}$$

D_{b} indicates whether sensitive data in the network is stored in an encrypted manner. For example, if all sensitive data in the network is stored in an encrypted manner, D_{b} is 5, if partial sensitive data in the network is stored in an encrypted manner, D_{b} is 2, and if none of the sensitive data in the network is stored in an encrypted manner, D_{b} is 0.
D_{c} indicates whether sensitive data in the network is transmitted in an encrypted manner. For example, if all sensitive data in the network is transmitted in an encrypted manner, D_{c} is 5, if partial sensitive data in the network is transmitted in an encrypted manner, D_{c} is 2, and if none of the sensitive data in the network is transmitted in an encrypted manner, D_{c} is 0.
D_{d} indicates whether sensitive data in the network is backed up in an offline or remote manner. For example, if all sensitive data in the network is backed up in an offline or remote manner, D_{d} is 5, if partial sensitive data in the network is backed up in an offline or remote manner, D_{d} is 2, and if none of the sensitive data in the network is backed up in an offline or remote manner, D_{d} is 0.
Dₑ indicates whether the network clears sensitive data in the network when the network is repaired or scrapped. For example, if all sensitive data in the network is cleared when the network is repaired or scrapped, Dₑ is 5, if partial sensitive data in the network is cleared when the network is repaired or scrapped, Dₑ is 2, and if none of the sensitive data in the network is cleared when the network is repaired or scrapped, Dₑ is 0.

In some embodiments, when D_{α}<0.5, the risk level is determined to be high risk. When 0.5≤D_{α}<0.8, the risk level is determined to be medium risk. When 0.8≤D_{α}≤1, the risk level is determined to be low risk. It can be understood that the values for determining the risk level above are merely for illustrative purpose, and other values may be used.

In some embodiments, the measurement frequency of the data protection ability D_{α} can be self-defined (e.g., per month, per quarter, half a year, or per year).

In some embodiments, the information of dealing or storing sensitive data in the network described above can be obtained or collected from at least one of: a configuration document, a backup record, an operation scheme, an operation logs, a security monitoring record, a manual check record, and/or a data clearance record.

It can be understood that some factors in the equation for calculating D_{α} may be omitted, and the denominator may change accordingly (e.g., from 20 to 15).

It can be understood that the values of each factor in the equation for calculating D_{α} may be set as different values (e.g., Dₑ is set as 7 if all sensitive data in the network is cleared when the network is repaired or scrapped), and the denominator may change accordingly (e.g., from 20 to 22).

### B. Security Detection

In some embodiments, the security detection function aims to identify the security incidents that are likely to occur or already occurred. In some embodiments, the risk detection ability and the incident detection ability may be used to depict the security detection ability.

### (1) Risk Detection Ability

In some embodiments, as internal and external environments change, the security of the system may vary due to new vulnerabilities, configuration errors, and inadvertently enabled services or ports. Thus, regularly sorting network systems, identifying and evaluating related risks may be needed. Details of the risk detection ability are discussed below.

In some embodiments, the measurement of the risk detection ability may be to ensure that main risks (e.g., vulnerabilities and baseline variations) are fully identified.

In some embodiments, the risk detection ability is determined by risk detection information of devices in the network, and the risk detection information comprises at least one of:
a number of devices undergoing both vulnerability scanning and baseline compliance checks; and/or
a number of devices undergoing only baseline compliance checks.

For example the risk detection ability R_{α} is determined by:

$${R}_{a} = \frac{{R}_{b} + 0.5 {R}_{c}}{{N}_{s}}$$

wherein Nₛ indicates a total amount of devices in the network;
wherein R_{b} indicates a number of devices undergoing both vulnerability scanning and baseline compliance checks; and
wherein R_{c} indicates a number of devices undergoing only baseline compliance checks.

In some embodiments, when R_{α}<0.5, the risk level is determined to be high risk. When 0.5≤R_{α}<0.8, the risk level is determined to be medium risk. When 0.8≤R_{α}≤1, the risk level is determined to be low risk. It can be understood that the values for determining the risk level above are merely for illustrative purpose, and other values may be used.

In some embodiments, the measurement frequency of the risk detection ability R_{α} can be self-defined (e.g., per month, per quarter, half a year, or per year).

In some embodiments, the risk detection information described above can be obtained or collected from at least one of: a vulnerability scanning report and/or a baseline compliance check report.

It can be understood that one of R_{b} or R_{c} in the equation for calculating R_{α} may be omitted

$$( e . g . , {R}_{a} = \frac{{R}_{b}}{{N}_{s}} ) .$$

It can be understood that at least one of the weights of R_{b} or R_{c} in the equation for calculating R_{α} may be changed

$$( e . g . , {R}_{a} = \frac{{R}_{b} + 0.7 {R}_{c}}{{N}_{s}} ) .$$

### (2) Incident Detection Ability

In some embodiments, security incidents may include at least one of an unauthorized operation, a manual operation error, account sharing, a brute-force attack, virus infection, data tampering or disclosure, a DOS (Denial-of-Service) attack. When attackers break the network perimeter, the internal security system and mechanism acting as the second line of defense may accurately detect security incidents as early as possible, and inform related personnel to handle them. Details of the incident detection ability are discussed below.

In some embodiments, the measurement of the incident detection ability may be to ensure that security incidents can be accurately detected.

In some embodiments, the incident detection ability is determined by incident detection information of the network, and the incident detection information comprises at least one of:
a number of times of security incidents reported within a pre-determined time (e.g., number of alarms);
a number of times of security incidents wrongly reported within a pre-determined time; and/or
a number of security incidents occurring within a pre-determined time.

For example, the incident detection ability I_{α} is determined by:

$${I}_{a} = \frac{{I}_{b} - {I}_{c}}{{I}_{d}}$$

wherein I_{b} indicates a number of times of security incidents reported within a pre-determined time (e.g., number of alarms);
wherein I_{c} indicates a number of times of security incidents wrongly reported within a pre-determined time; and
wherein I_{d} indicates a number of security incidents occurring within the pre-determined time.

In some embodiments, when I_{α}<0.5, the risk level is determined to be high risk. When 0.5≤I_{α}<0.8, the risk level is determined to be medium risk. When 0.8≤I_{α}≤1, the risk level is determined to be low risk. It can be understood that the values for determining the risk level above are merely for illustrative purpose, and other values may be used.

In some embodiments, the measurement frequency of the incident detection ability I_{α} can be self-defined (e.g., per month, per quarter, half a year, or per year).

In some embodiments, the incident detection information described above can be obtained or collected from at least one of: a security incident report, a security detection report of a host, a security audit report, an operation log, a security log, an alarm log, and/or individual observation information.

It can be understood that I_{c} in the equation for calculating I_{α} may be omitted

$$( e . g . , {I}_{a} = \frac{{I}_{b}}{{I}_{d}} ) .$$

It can be understood that at least one of the weights of I_{b} or I_{c} in the equation for calculating I_{α} may be changed

$$( e . g . , {I}_{a} = \frac{1.5 {I}_{b} - 1.5 {I}_{c}}{{I}_{d}} ) .$$

### C. Security Recovery

In some embodiments, the security recovery function may reduce the impact on the network due to incidents, which may be depicted by incident recovery ability, vulnerability handling ability, and emergency response ability.

### (1) Incident Recovery Ability

After a network is intruded, if containment and eradication actions are not rapidly carried out, irreversible damage may be caused. For example, worm viruses spread very fast in a network, and may infect a large number of systems in a short time, causing network crashes. By counting statistics on the security incident recovery capability, the related operations of the organization are monitored, and performance is improved in a timely manner. Details of the incident recovery ability are discussed below.

In some embodiments, the measurement of the incident recovery ability may be to ensure that security incidents can be rapidly contained or eradicated within a defined time.

In some embodiments, the incident recovery ability is determined by incident recovery information of the network, and the incident recovery information comprises at least one of:
a number of incidents contained or eradicated during a first pre-determined time; and/or
a number of incidents occurring during a second pre-determined time. The first pre-determined time may be the same as or different from the second pre-determined time.

For example, the incident recovery ability C_{α} is determined by:

$${C}_{a} = \frac{{C}_{b}}{{C}_{c}}$$

wherein C_{b} indicates a number of incidents contained or eradicated during a first pre-determined time; and
wherein C_{c} indicates a number of incidents occurring during a second pre-determined time.

In some embodiments, when C_{α}<0.5, the risk level is determined to be high risk. When 0.5≤C_{α}<0.8, the risk level is determined to be medium risk. When 0.8≤C_{α}≤1, the risk level is determined to be low risk. It can be understood that the values for determining the risk level above are merely for illustrative purpose, and other values may be used.

In some embodiments, the measurement frequency of the incident recovery ability C_{α} can be self-defined (e.g., per month, per quarter, half a year, or per year).

In some embodiments, the incident recovery information described above can be obtained or collected from at least one of: an SIEM (Security Information and Event Management) security monitoring report, a security monitoring report of a host, a network change record, an operation log, a security log, and/or an alarm.

### (2) Vulnerability Handling Ability

In some embodiments, vulnerabilities may indicate inherent defects in the design, configuration, or implementation of system hardware and software. If high-risk or medium-risk vulnerabilities are maliciously exploited by attackers, the network may be seriously damaged. Details of the vulnerability handling ability are discussed below. In some embodiments, the high-risk vulnerabilities may indicate vulnerabilities that can cause high impact, such as denial of service and execution of arbitrary code on the targeted system. In some embodiments, the medium-risk vulnerabilities may indicate vulnerabilities that can cause medium impact, such as elevation of privilege, security restriction bypass, information disclosure and data manipulation.

In some embodiments, the measurement of the vulnerability handling ability may be to ensure that high-risk and medium-risk vulnerabilities are mitigated or resolved in a timely manner.

In some embodiments, the vulnerability handling ability is determined by vulnerability handling information of the network, and the vulnerability handling information comprises at least one of:
a number of high-risk and medium-risk vulnerabilities mitigated or resolved within a third pre-determined time; and/or
a number of high-risk and medium-risk vulnerabilities identified within a fourth pre-determined time. The third pre-determined time may be the same as or different from the fourth pre-determined time.

For example, the vulnerability handling ability V_{α} is determined by:

$${V}_{a} = \frac{{V}_{b}}{{V}_{c}}$$

wherein V_{b} indicates a number of high-risk and medium-risk vulnerabilities mitigated or resolved within a pre-determined time; and
wherein V_{c} indicates a number of high-risk and medium-risk vulnerabilities identified within the pre-determined time.

In some embodiments, when V_{α}<0.5, the risk level is determined to be high risk. When 0.5≤V_{α}<0.8, the risk level is determined to be medium risk. When 0.8≤V_{α}≤1, the risk level is determined to be low risk. It can be understood that the values for determining the risk level above are merely for illustrative purpose, and other values may be used.

In some embodiments, the measurement frequency of the vulnerability handling ability Va can be self-defined (e.g., per month, per quarter, half a year, or per year).

In some embodiments, the vulnerability handling information described above can be obtained or collected from at least one of: a vulnerability scanning report, a threat intelligence, a network change record, and/or an operation log.

### (3) Emergency Response Ability

In some embodiments, the emergency response ability of the network may be reflected through emergency drills. The emergency drills may test the emergency response of the network in case of unexpected situations, so as to ensure the availability of critical systems and resources. The more systems (e.g., the data collecting system, the data processing system, the management system and so on.) are covered, the better the emergency response capability of the network. Details of the emergency response ability are discussed below.

In some embodiments, the measurement of the emergency response ability may be to ensure that unexpected disasters and attacks can be orderly handled.

In some embodiments, the emergency response ability is determined by emergency response information of systems in the network, and the emergency response information comprises at least one of:
a number of systems in the network passing emergency drills (e.g., month emergency drills, quarter emergency drills, half-year emergency drills, or annual emergency drills); and/or
a number of systems in the network.

For example, the emergency response ability E_{α} is determined by:

$${E}_{a} = \frac{{E}_{b}}{{E}_{c}}$$

wherein E_{b} indicates a number of systems in the network passing emergency drills; and
wherein E_{c} indicates a number of systems in the network.

In some embodiments, when E_{α}<0.5, the risk level is determined to be high risk. When 0.5≤E_{α}<0.8, the risk level is determined to be medium risk. When 0.8≤E_{α}≤1, the risk level is determined to be low risk. It can be understood that the values for determining the risk level above are merely for illustrative purpose, and other values may be used.

In some embodiments, the measurement frequency of the emergency response ability E_{α} can be self-defined (e.g., per month, per quarter, half a year, or per year).

In some embodiments, the emergency response information described above can be obtained or collected from at least one of an emergency drill report.

In some embodiments of the present disclosure, an indicator system for network security evaluation is proposed.

In some embodiments of the present disclosure, the indicators to characterize the security status of a network is defined according to the PDR model.

In some embodiments of the present disclosure, for each indicator, the measurement formula is designed, enabling the evaluation of the network security in a quantifiable way.

In some embodiments of the present disclosure, for each indicator, a risk range is proposed, enabling an understandable evaluation result outputted from the proposed system.

In the paragraphs below, details will be described along with some examples, but the present disclosure is not limited to the example below.

FIG. 2 relates to a diagram of an evaluation device 30 according to an embodiment of the present disclosure. The evaluation device 30 may be a mobile phone, a laptop, a desktop, a tablet computer, an electronic book or a computer system and is not limited herein. The evaluation device 30 may include a processor 300 such as a central processing unit or Application Specific Integrated Circuit (ASIC), a storage unit 310 and a communication unit 320. The storage unit 310 may be any data storage device that stores a program code 312, which is accessed and executed by the processor 300. Embodiments of the storage code 312 include but are not limited to a subscriber identity module (SIM), read-only memory (ROM), flash memory, random-access memory (RAM), hard-disk, and optical data storage device. The communication unit 320 may a transceiver and is used to transmit and receive signals (e.g., messages or packets) according to processing results of the processor 300. In an embodiment, the communication unit 320 transmits and receives the signals via at least one antenna 322 or via wire.

In an embodiment, the storage unit 310 and the program code 312 may be omitted and the processor 300 may include a storage unit with stored program code.

The processor 300 may implement any one of the steps in exemplified embodiments on the evaluation device 30, e.g., by executing the program code 312.

The communication unit 320 may be a transceiver. The communication unit 320 may as an alternative or in addition be combining a transmitting unit and a receiving unit configured to transmit and to receive, respectively, signals to and from another device.

In some embodiments, the evaluation device 30 may be used to perform the operations described in this disclosure. In some embodiments, the processor 300 and the communication unit 320 collaboratively perform the operations described in this disclosure. For example, the processor 300 performs the evaluation and transmit or receive signals, message, and/or information through the communication unit 320.

A network security evaluation method is also provided according to an embodiment of the present disclosure. In an embodiment, the network security evaluation method may be performed by using an evaluation device. In an embodiment, the network security evaluation device may be implemented by using the evaluation device 30 described in this disclosure, but is not limited thereto.

Referring to FIG. 3, in an embodiment, the network security evaluation method includes: quantifying, by a processor, one or more quantified indicators indicating one or more risk levels of a network according to security data of the network; and analyzing, by the processor, the one or more quantified indicators for a security improvement of the network in response to the one or more risk levels of the network being greater than one or more criteria.

In some embodiments, the security data may indicate the reports, the logs, the information, the records described above used for obtaining or collecting the information for determining the one or more quantified indicators.

In some embodiments, the one or more quantified indicators indicate an ability of at least one of: a security protection function of the network, a security detection function of the network, or a security recovery function of the network.

In some embodiments, the one or more quantified indicators comprises at least one of the following indicators described above:
a personnel protection ability;
a system protection ability;
a data protection ability;
a risk detection ability;
an incident detection ability;
an incident recovery ability;
a vulnerability handling ability; and/or
an emergency response ability.

In some embodiments, the security improvement of the network may indicate one or more measurements for improving the one or more quantified indicators, such as controlling the devices in the network to be installed with self-protection software, configuring the devices in the network to have stronger identity authentications, making all sensitive data in the network to be transmitted in an encrypted manner, and so on. In some embodiments, the security improvement of the network may be determined or generated according to the one or more quantified indicators and/or the one or more criteria.

For example, when the risk level(s) corresponding to the data protection ability is greater than the one or more criteria, the security improvement of the network may be determined or generated to be at least one of making all or part of sensitive data in the network to be stored in an encrypted manner, making all or part of sensitive data in the network to be backed up in an offline or remote manner, and/or making all or part of sensitive data in the network to be cleared when the network is repaired or scrapped.

Details in this regard can be ascertained with reference to the paragraphs above, and will not be repeated herein.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is understood that, in the present disclosure, the term “and/or” or symbol “/” may include any or all combinations of one or more of the associated listed items. For example, A and/or B and/or C includes any and all combinations of one or more of A, B, and C, including A, B, C, A and B, A and C, B and C, and a combination of A, B and C. Likewise, A/B/C includes any and all combinations of one or more of A, B, and C, including A, B, C, A and B, A and C, B and C, and a combination of A and B and C.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general-purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general-purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A network security evaluation method comprising:
quantifying, by a processor, one or more quantified indicators indicating one or more risk levels of a network according to security data of the network; and
analyzing, by the processor, the one or more quantified indicators for a security improvement of the network in response to the one or more risk levels of the network being greater than one or more criteria;
wherein the one or more quantified indicators indicate an ability of at least one of: a security protection function of the network, a security detection function of the network, or a security recovery function of the network.

2. The network security evaluation method of claim 1, wherein the one or more quantified indicators comprises at least one of:
a personnel protection ability;
a system protection ability;
a data protection ability;
a risk detection ability;
an incident detection ability;
an incident recovery ability;
a vulnerability handling ability; or
an emergency response ability.

3. The network security evaluation method of claim 2, wherein the personnel protection ability is determined by training information of network operators for the network, and the training information comprises at least one of: information of an adequacy level of a security training of one of the network operators or information of a qualification level of a security training of one of the network operators.

4. The network security evaluation method of claim 2, wherein the personnel protection ability H_{α} is determined by:
$${H}_{a} = \frac{{\sum }_{i = 1}^{{N}_{h}} {H}_{{a}_{i}}}{{N}_{h}}$$
wherein Nₕ indicates a total amount of network operators for the network,
wherein H_{α}_{ᵢ}=0.5H_{b}_{ᵢ}+0.5H_{c}_{ᵢ},
wherein H_{b}_{ᵢ} indicates an adequacy level of a security training of operator i, and
wherein H_{c}_{ᵢ} indicates a qualification level of a security training of operator i.

5. The network security evaluation method of claim 2, wherein the system protection ability is determined by protection information of devices in the network, and the protection information comprises at least one of:
a strength of an identity authentication of one of the devices;
an indication indicating whether one of the devices is installed with a self-protection software;
an indication indicating whether a patch of one of the devices meets certain requirements;
an indication indicating whether one of the devices is intruded;
an indication indicating whether one of the devices has undergone a security reinforcement;
an indication indicating whether one of the devices has a software whitelist enabled;
an indication indicating whether one of the devices has a redundancy design; or
an indication indicating whether one of the devices has an account security policy enabled.

6. The network security evaluation method of claim 2, wherein the system protection ability S_{α} is determined by:
$${S}_{a} = \frac{{\sum }_{i = 1}^{{N}_{s}} {S}_{{a}_{i}}}{{N}_{s}}$$
wherein Nₛ indicates a total amount of devices in the network,
wherein
$${S}_{{a}_{i}} = \frac{{S}_{{b}_{i}} + {S}_{{c}_{i}} + {S}_{{d}_{i}} + {S}_{{e}_{i}} + {S}_{{f}_{i}} + {S}_{{g}_{i}} + {S}_{{h}_{i}} + {S}_{{j}_{i}}}{18} ,$$
wherein S_{b}_{ᵢ} indicates a strength of an identity authentication of device i;
wherein S_{c}_{ᵢ} indicates whether device i is installed with a self-protection software;
wherein S_{d}_{ᵢ} indicates whether a patch of device i meets certain requirements;
wherein Sₑ_{ᵢ} indicates whether device i is intruded;
wherein S_{f}_{ᵢ} indicates whether device i is undergone a security reinforcement;
wherein S_{g}_{ᵢ} indicates whether device i has a software whitelist enabled;
wherein Sₕ_{ᵢ} indicates whether device i has a redundancy design; and
wherein Sⱼ_{ᵢ} indicates whether device i has an account security policy enabled.

7. The network security evaluation method of claim 2, wherein the data protection ability is determined by information of dealing or storing sensitive data in the network, and the information of dealing or storing sensitive data in the network comprises at least one of:
an indication indicating whether the sensitive data is stored in an encrypted manner;
an indication indicating whether the sensitive data is transmitted in an encrypted manner;
an indication indicating whether the sensitive data is backed up in an offline or remote manner; or
an indication indicating whether the network clears the sensitive data when the network is repaired or scrapped.

8. The network security evaluation method of claim 2, wherein the data protection ability D_{α} is determined by:
$${D}_{a} = \frac{{D}_{b} + {D}_{c} + {D}_{d} + {D}_{e}}{20}$$
wherein D_{b} indicates whether sensitive data in the network is stored in an encrypted manner;
wherein D_{c} indicates whether sensitive data in the network is transmitted in an encrypted manner;
wherein D_{d} indicates whether sensitive data in the network is backed up in an offline or remote manner; and
wherein Dₑ indicates whether the network clears sensitive data in the network when the network is repaired or scrapped.

9. The network security evaluation method of claim 2, wherein the risk detection ability is determined by risk detection information of devices in the network, and the risk detection information comprises at least one of:
a number of devices undergoing both vulnerability scanning and baseline compliance checks; or
a number of devices undergoing only baseline compliance checks.

10. The network security evaluation method of claim 2, wherein the risk detection ability R_{α} is determined by:
$${R}_{a} = \frac{{R}_{b} + 0.5 {R}_{c}}{{N}_{s}}$$
wherein Nₛ indicates a total amount of devices in the network;
wherein R_{b} indicates a number of devices undergoing both vulnerability scanning and baseline compliance checks; and
wherein R_{c} indicates a number of devices undergoing only baseline compliance checks.

11. The network security evaluation method of claim 2, wherein the incident detection ability is determined by incident detection information of the network, and the incident detection information comprises at least one of:
a number of times of security incidents reported within a pre-determined time;
a number of times of security incidents wrongly reported within a pre-determined time; or
a number of security incidents occurring within a pre-determined time.

12. The network security evaluation method of claim 2, wherein the incident detection ability I_{α} is determined by:
$${I}_{a} = \frac{{I}_{b} - {I}_{c}}{{I}_{d}}$$
wherein I_{b} indicates a number of times of security incidents reported within a pre-determined time;
wherein I_{c} indicates a number of times of security incidents wrongly reported within a pre-determined time; and
wherein I_{d} indicates a number of security incidents occurring within the pre-determined time.

13. The network security evaluation method of claim 2, wherein the incident recovery ability is determined by incident recovery information of the network, and the incident recovery information comprises at least one of:
a number of incidents contained or eradicated during a first pre-determined time; or
a number of incidents occurring during a second pre-determined time.

14. The network security evaluation method of claim 2, wherein the incident recovery ability C_{α} is determined by:
$${C}_{a} = \frac{{C}_{b}}{{C}_{c}}$$
wherein C_{b} indicates a number of incidents contained or eradicated during a first pre-determined time; and
wherein C_{c} indicates a number of incidents occurring during a second pre-determined time.

15. The network security evaluation method of claim 2, wherein the vulnerability handling ability is determined by vulnerability handling information of the network, and the vulnerability handling information comprises at least one of:
a number of high-risk and medium-risk vulnerabilities mitigated or resolved within a third pre-determined time; or
a number of high-risk and medium-risk vulnerabilities identified within a fourth pre-determined time.

16. The network security evaluation method of claim 2, wherein the vulnerability handling ability V_{α} is determined by:
$${V}_{a} = \frac{{V}_{b}}{{V}_{c}}$$
wherein V_{b} indicates a number of high-risk and medium-risk vulnerabilities mitigated or resolved within a third pre-determined time; and
wherein V_{c} indicates a number of high-risk and medium-risk vulnerabilities identified within a fourth pre-determined time.

17. The network security evaluation method of claim 2, wherein the emergency response ability is determined by emergency response information of systems in the network, and the emergency response information comprises at least one of:
a number of systems in the network passing emergency drills; or
a number of systems in the network.

18. The network security evaluation method of claim 2, wherein the emergency response ability E_{α} is determined by:
$${E}_{a} = \frac{{E}_{b}}{{E}_{c}}$$
wherein E_{b} indicates a number of systems in the network passing emergency drills; and
wherein E_{c} indicates a number of systems in the network.

19. An evaluation device, comprising:
a processor configured to: quantify one or more quantified indicators indicating one or more risk levels of the network according to security data of the network; and analyze the one or more quantified indicators for a security improvement of the network in response to the one or more risk levels of the network being greater than one or more criteria, wherein the one or more quantified indicators indicate an ability of at least one of: a security protection function of the network, a security detection function of the network, or a security recovery function of the network.

20. The evaluation device of claim 19, wherein the processor is further configured to perform a network security evaluation method of claim 2.

21. (canceled)
